(19) United States
(12) Patent Application Publication
(10) Pub. No.: US 2018/0137302 A1
(43) Pub. Date: May 17, 2018

(54) TECHNIQUES AND ARCHITECTURES FOR FIELD AND/OR RECORD LEVEL SECURITY MECHANISMS

(71) Applicant: salesforce.com, inc., San Francisco, CA (US)

(72) Inventor: Tyler Crimm, Brush Prairie, WA (US)

(21) Appl. No.: 15/372,266

(22) Filed: Dec. 7, 2016

Related U.S. Application Data
(60) Provisional application No. 62/366,776, filed on Jul. 26, 2016.

(51) Int. Cl. G06F 21/62; H04L 9/14; G06F 21/60

(52) U.S. Cl. CPC G06F 21/6227; G06F 2221/2107; G06F 21/602; H04L 9/14

(57) ABSTRACT

Architectures and techniques for encrypting data stored in a database table. Data to be stored in the database table is encrypted on a sub-row basis. The encryption is performed using different encryption keys for each entity authorized to access the corresponding field. The encrypted data is stored in a selected row in the database table. An encrypted block of data from the row is sent to a requesting electronic device. The block of data includes the selected sub-row data and other encrypted data to be decrypted using an encryption key corresponding to the requesting electronic device. The encryption key allows decryption of the data corresponding to an authorized entity, but not all of the block of data.

### CLAIM OF PRIORITY

This application claims the benefit of U.S. Provisional Patent Application No. 62/366,776, entitled “Field/Record Level Security/Encryption at Rest” by Tyler Crimm, filed Jul. 26, 2016, the contents of which are fully incorporated by reference herein.

### TECHNICAL FIELD

Embodiments relate to security mechanisms for fields and/or records in an on-demand services environment. More particularly, embodiments relate to techniques and mechanisms for efficiently providing field-level and/or record-level security within an on-demand services environment.

### BACKGROUND

Data that is used and managed by computing environments (e.g., databases, on-demand service environments, cloud platforms) is generally secured in some manner. Various techniques exist for providing security. However, this security is generally provided at the organization or application or file level. There are many situations in which a more granular approach to security is desirable.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of an architecture that can provide field and/or object level security as described herein.

FIG. 2 is a block diagram of one embodiment of an electronic system.

FIG. 3 is a flow diagram of one embodiment of a technique for encrypting data.

FIG. 4 is a flow diagram of one embodiment of a technique for decrypting data.

FIG. 5 is a conceptual illustration of one embodiment of key management.

FIG. 6 is a block diagram of one embodiment of an encryption management agent.

FIG. 7 is a block diagram of one embodiment of an on-demand services environment.

FIG. 8 is a block diagram of one embodiment of an on-demand services environment.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

The security techniques described herein can be utilized, for example, in an environment in which multiple users can have access to objects (e.g., record type, Salesforce custom objects, files) and/or fields within objects. Various embodiments of the techniques can allow users secure access on an object-by-object or field-by-field basis. In one embodiment, each field is encrypted with all of the keys that are allowed to access the field. In one embodiment, each field is encrypted by at least a system master key. In various embodiments, master keys could be implemented on an individual field, record, table or functional level (e.g., a key can be used for encrypting all “name” fields in a table of for encrypting all fields in a particular record).

In one embodiment, additional keys can be added to the list of keys that can access a specific field by updating the key management mechanism and re-encrypting the original data to allow access. In one embodiment, key access can be removed by updating the key management mechanism and re-encrypting the original data to restrict access to valid keys. In one embodiment, each time a field is updated, the contents are re-encrypted with all valid keys found in the key management mechanism.

In one embodiment, each record (or object) is encrypted with all of the keys that are allowed to access the record/object. In one embodiment, each record/object is encrypted by at least a system master key. In various embodiments, master keys could be implemented on an individual object, record or functional level (e.g., a key can be used for encrypting all records of a particular table).

In one embodiment, additional keys can be added to the list of keys that can access a specific record/object by updating the key management mechanism and re-encrypting the original data to allow access. In one embodiment, key access can be removed by updating the key management mechanism and re-encrypting the original data to restrict access to valid keys. In one embodiment, each time a record/object is updated, the contents are re-encrypted with all valid keys found in the key management mechanism.

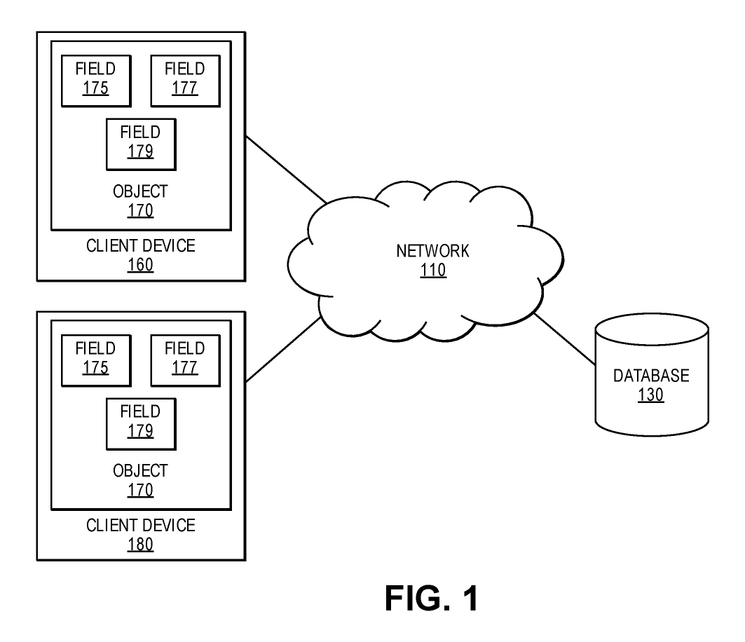

FIG. 1 is a block diagram of one embodiment of an architecture that can provide field and/or object level security as described herein. The example of FIG. 1 is a simple example with a small number of client devices, objects and fields. However, any number of client devices, objects and/or fields can be supported.

Network 110 can be any type of network (or combination of networks) that connects database 130 with one or more client devices (e.g., 160, 180). Database 130 functions to store in objects, fields and/or other structures. Database 130 can be part of an on-demand services environment, various embodiments of which are described in greater detail below.

Client devices 160 and 180 are electronic devices that allow a user to access data stored on database via network 110. Client devices 160 and 180 can be any type of electronic device, for example, a desktop computer system, a mobile computing system, a tablet, a smartphone, etc. One embodiment of an electronic device is described in greater detail below.

In one embodiment, when a client device requests data (e.g., a table, an object 170, multiple objects, multiple tables, fields 175, 177, 179) from database 130, the database management system returns at least the requesting data to the requesting client device. The client device then utilizes one or more encryption keys to decrypt the data that the user of the client device is authorized to access. The mechanisms by which the proper decryption is accomplished are described in greater detail below.

In one embodiment, data in database 130 is encrypted at rest. Each time an object is updated, the encryption mechanism updates and encrypts data on a field-by-field basis. In one embodiment, each field is encrypted with the key(s) of people who are authorized to access that field. In response to a request, all fields related to the record are returned, but the client device can only decrypt fields that the corresponding user is authorized to access because of the encryption keys involved. Data exists exactly once in database 130.

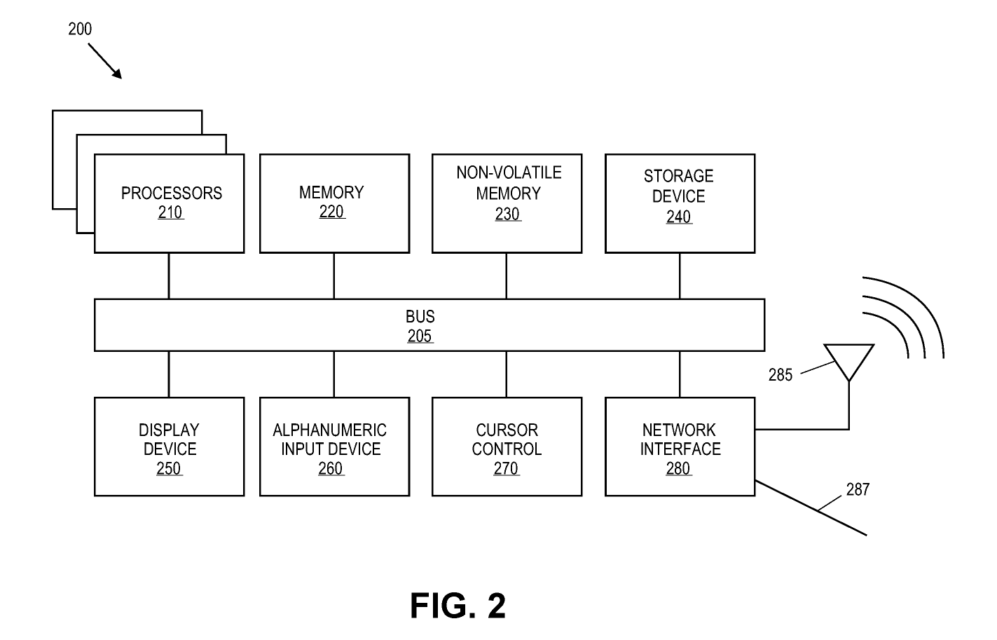

FIG. 2 is a block diagram of one embodiment of an electronic system. The electronic system illustrated in FIG. 2 is intended to represent a range of electronic systems (either wired or wireless) including, for example, desktop computer systems, laptop computer systems, cellular telephones, smartphones, tablets, wearable computing devices, etc. Alternative electronic systems may include more, fewer and/or different components.

Electronic system 200 includes bus 205 or other communication device to communicate information, and processor 210 coupled to bus 205 that may process information. While electronic system 200 is illustrated with a single processor, electronic system 200 may include multiple processors and/or co-processors. Electronic system 200 further may include random access memory (RAM) or other dynamic storage device 220 (referred to as main memory), coupled to bus 205 and may store information and instructions that may be executed by processor 210. Main memory 220 may also be used to store temporary variables or other intermediate information during execution of instructions by processor 210.

Electronic system 200 may also include read only memory (ROM) and/or other static storage device 230 coupled to bus 205 that may store static information and instructions for processor 210. Data storage device 240 may be coupled to bus 205 to store information and instructions. Data storage device 240 such as a magnetic disk or optical disc and corresponding drive may be coupled to electronic system 200.

Electronic system 200 may also be coupled via bus 205 to display device 250, such as a liquid crystal display (LCD) to display information to a user. Alphanumeric input device 260, including alphanumeric and other keys, may be coupled to bus 205 to communicate information and command selections to processor 210. Another type of user input device is cursor control 270, such as a mouse, a trackball, or cursor direction keys to communicate direction information and command selections to processor 210 and to control cursor movement on display 250.

Electronic system 200 further may include network interface(s) 280 to provide access to a network, such as a local area network. Network interface(s) 280 may include, for example, a wireless network interface having antenna 285, which may represent one or more antenna(e). Network interface(s) 280 may also include, for example, a wired network interface to communicate with remote devices via network cable 287, which may be, for example, an Ethernet cable, a coaxial cable, a fiber optic cable, a serial cable, or a parallel cable.

In one embodiment, network interface(s) 280 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 280 may provide wireless communications using, for example, Time Division, Multiple Access (TDMA) protocols, Global System for Mobile Communications (GSM) protocols, Code Division, Multiple Access (CDMA) protocols, Long Term Evolution (LTE) and/or any other type of wireless communications protocol.

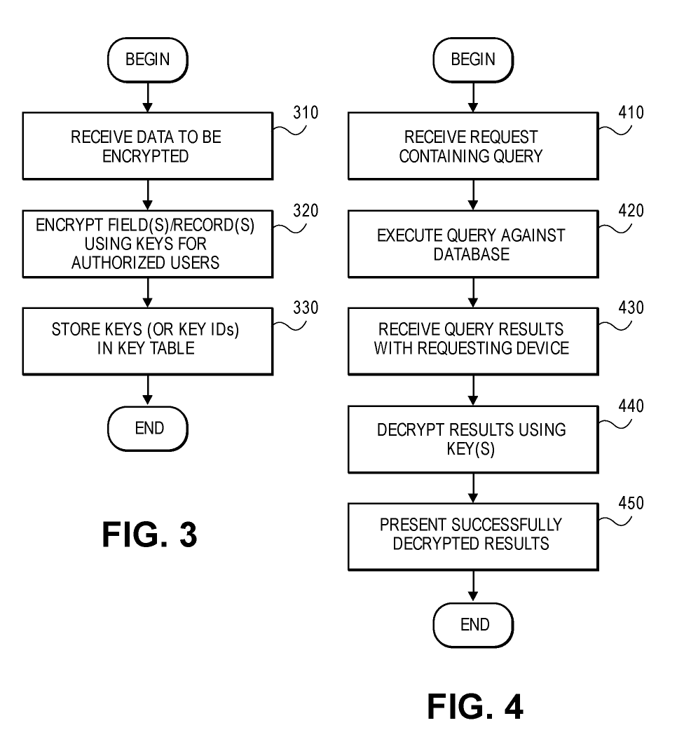

FIG. 3 is a flow diagram of one embodiment of a technique for encrypting data. The data to be encrypted is received, 310. In the database environment described herein, data can be received to be stored in a field or a record. The data can be received via a graphical user interface (GUI) from user input or via an application program interface (API), for example. While many of the examples herein relate to on-demand services environments including multitenant environments, the techniques described herein are not limited to use in those environments.

The field(s)/record(s) are encrypted using the keys corresponding to the authorized user(s), 320. As discussed above, a field/record is encrypted with keys corresponding to all of the entities allowed to access the field/record. In one embodiment, data is encrypted with multiple keys for later decryption by individual keys. This can be done on a field-by-field or a record-by-record basis. The encrypted field/record is then stored in the secure environment and can be available for subsequent accesses.

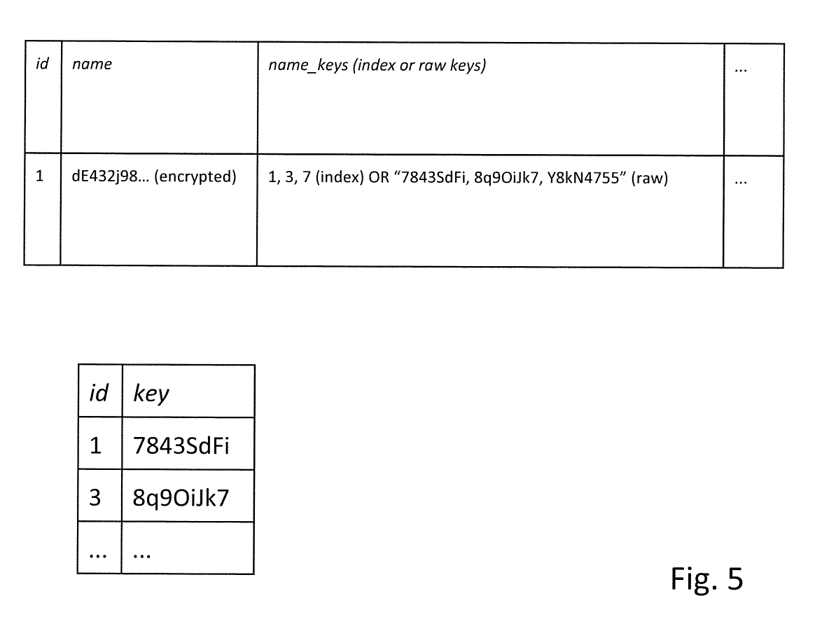

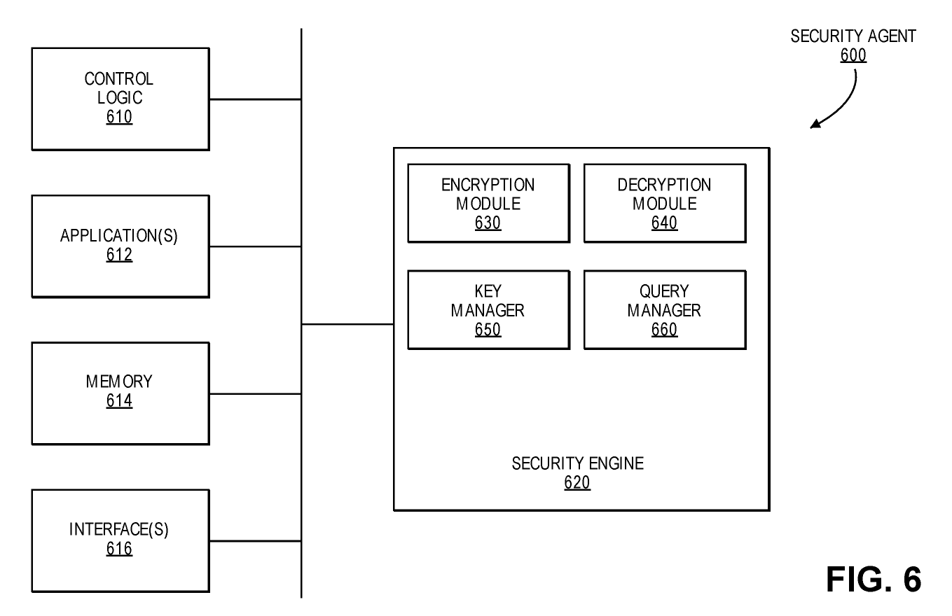

In one embodiment, the key(s) used to encrypt the field/record are stored in a key table, 330. Various techniques for storing keys in the key table and retrieving keys from the key table are discussed in greater detail below in, for example, FIGS. 5 and 6.

FIG. 4 is a flow diagram of one embodiment of a technique for decrypting data. In one embodiment, the decrypting is performed by a client computing device (e.g., FIG. 2) that requests data from a secure environment. In other embodiments, decryption can be performed by other components.

In one embodiment, a request is received that includes a query, 410. The query can be executed against a data store (e.g., a database) to retrieve data that has been encrypted as described herein. In one embodiment, the request is received in the secure environment in which the encrypted data is stored, for example, an on-demand services environment.

The query is executed against the database, 420. The query results are received by the requesting device, 430. The query results can return more data than the requesting party is authorized to access. In one embodiment, the results that are returned are not based on the authorization level of the requesting party. That is, the results of the query are returned whether or not the requesting party has authorization to access all of the data in the result.

The requesting device decrypts the results using one or more keys corresponding to the party making the request, 440. Because the data has been encrypted on a field-by-field (or record-by-record) basis using the keys of the authorized parties, the requesting device will be able to decrypt the data that the requestor is authorized to access and will not be able to decrypt the other data in the result.

The successfully decrypted data can then be presented to the requesting party, 450. This can be accomplished, for example, with a graphical user interface, or the decrypted data can be stored for later use.

FIG. 5 is a conceptual illustration of one embodiment of key management. The example of FIG. 5 represents different permutations for how storing the keys in the field can be implemented, as well as how keys could be stored by adding an additional field to the record to hold the keys—either accessing raw keys or pointing to indexes that contain the possible keys. The following code describes two example embodiments for field-by-field encryption.
Keys in field payload:

var data = {

keys: [“885sxT4”, “SA782Gv8”],
encrypted_data: “dm732rq67...”

};

Keys in system encrypted field payload:
var unencrypted_payload =field.decrypt(Keys.system);

var data = {

keys: [“885sxT4”, “SA782Gv8”],
encrypted_data: “dm732rq67...”

};

The keys can be stored either as raw keys in a key table or key IDs can be stored in the key table.

The following code describes two example embodiments for record-by-record encryption.
Keys in field payload:

var data = {

keys: [“885sxT4”, “SA782Gv8”],
encrypted_data: “dm732rq67...”

};

Keys in system encrypted field payload:
var unencrypted_payload=record.decrypt(Keys.system);

var data = {

keys: [“885sxT4”, “SA782Gv8”],
encrypted_data: “dm732rq67...”

};

The keys can be stored either as raw keys in a key table or key IDs can be stored in the key table. A permutation of field-level encryption and record-level encryption can be provided with multiple layers to the encryption implementation.

In one embodiment, an unencrypted shadow database can be maintained for search and/or indexing functionality. In one embodiment, encrypted and unencrypted fields within the same record can be paired and access within the secure environment can be provided by the unencrypted data while the encrypted data is provided outside the secure environment (e.g., name system (raw) and name encrypted (encrypted)).

FIG. 6 is a block diagram of one embodiment of an encryption management agent. In one embodiment, security agent 600 includes control logic 610, which implements logical functional control to direct operation of security agent 600, and/or hardware associated with directing operation of security agent 600. Logic may be hardware logic circuits and/or software routines. In one embodiment, security agent 600 can be part of an on-demand services environment, various example embodiments of which are described in greater detail below.

In one embodiment, security agent 600 includes one or more applications 612, which represent code sequence and/or programs that provide instructions to control logic 610. Applications can provide various functional components of security agent 600.

Security agent 600 includes memory 614, which represents a memory device and/or access to a memory resource for storing data and/or instructions. Memory 614 may include memory local to security agent 600, as well as, or alternatively, including memory of the host system on which security agent 600 resides.

In one embodiment, security agent 600 also includes one or more interfaces 616, which represent access interfaces to/from (an input/output interface) security agent 600 with regard to entities (electronic or human) external to security agent 600. Interface(s) 616 can include, for example, the various APIs utilized to perform the functionality described above and/or the user interface discussed above. Other and/or different and/or additional interfaces can also be provided.

Security agent 600 also includes security engine 620, which includes one or more functions or modules that enable security agent 600 to provide the records management services as described above. The example of FIG. 6 provides several modules that may be included in security engine 620; however, different and/or additional modules may also be included. Example modules that may be involved include encryption module 630, decryption module 640, key manager 650 and query manager 660. The modules of security engine 620 can be hardware, software or a combination thereof.

In one embodiment, encryption module 630 functions to perform the encryption operations as described herein. Encryption module 630 can be part of the host secure environment and/or part of the client device providing the data to be stored in the host environment. Thus, encryption module 630 can be part of the secure environment, part of the client device or split between them.

In one embodiment, decryption module 640 functions to perform the encryption operations as described herein. Decryption module 640 can be part of the host secure environment and/or part of the client device providing the data to be stored in the host environment. Thus, decryption module 640 can be part of the secure environment, part of the client device or split between them.

In one embodiment, key manager 650 functions to maintain keys to be used for encryption and decryption as described herein. As discussed above, keys can be stored in a key table and/or key identifiers can be maintained in the key table. In one embodiment, query manager 660 functions to manage data queries as described herein.

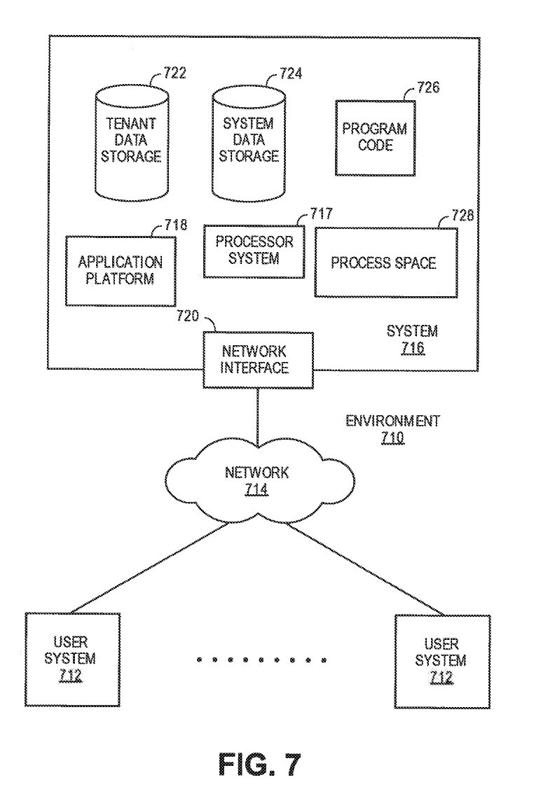

FIG. 7 illustrates a block diagram of an environment 710 wherein an on-demand database service might be used. Environment 710 may include user systems 712, network 714, system 716, processor system 717, application platform 718, network interface 720, tenant data storage 722, system data storage 724, program code 726, and process space 728. In other embodiments, environment 710 may not have all of the components listed and/or may have other elements instead of, or in addition to, those listed above.

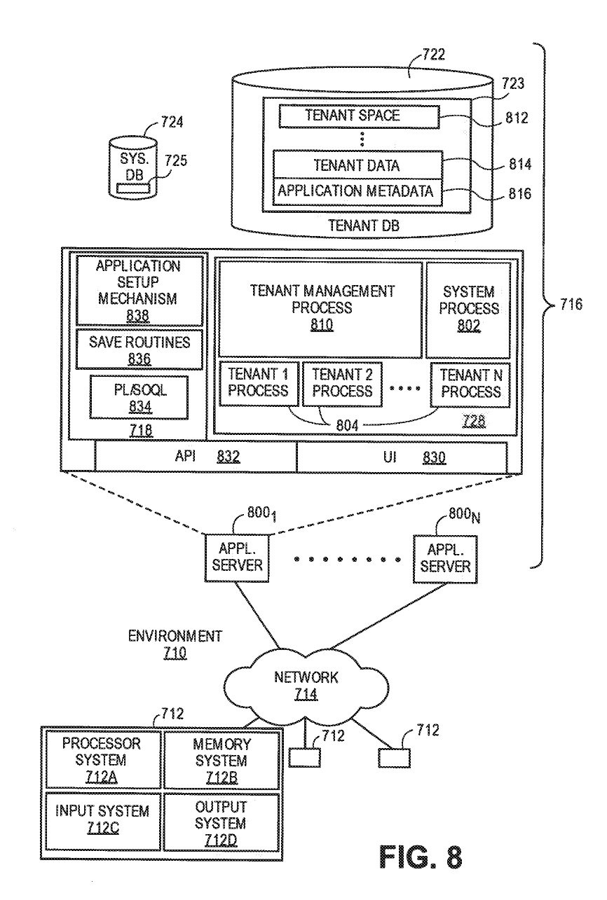

Environment 710 is an environment in which an on-demand database service exists. User system 712 may be any machine or system that is used by a user to access a database user system. For example, any of user systems 712 can be a handheld computing device, a mobile phone, a laptop computer, a work station, and/or a network of computing devices. As illustrated in herein FIG. 7 (and in more detail in FIG. 8) user systems 712 might interact via a network 714 with an on-demand database service, which is system 716.

An on-demand database service, such as system 716, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 716” and “system 716” will be used interchangeably herein. A database image may include one or more database objects. A relational database management system (RDMS) or the equivalent may execute storage and retrieval of information against the database object(s). Application platform 718 may be a framework that allows the applications of system 716 to run, such as the hardware and/or software, e.g., the operating system. In an embodiment, on-demand database service 716 may include an application platform 718 that enables creation, managing and executing one or more applications developed by the provider of the on-demand database service, users accessing the on-demand database service via user systems 712, or third party application developers accessing the on-demand database service via user systems 712.

The users of user systems 712 may differ in their respective capacities, and the capacity of a particular user system 712 might be entirely determined by permissions (permission levels) for the current user. For example, where a salesperson is using a particular user system 712 to interact with system 716, that user system has the capacities allotted to that salesperson. However, while an administrator is using that user system to interact with system 716, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 714 is any network or combination of networks of devices that communicate with one another. For example, network 714 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 712 might communicate with system 716 using TCP/IP and, at a higher network level, use other common Internet protocols to communicate, such as HTTP, FTP, AFS, WAP, etc. In an example where HTTP is used, user system 712 might include an HTTP client commonly referred to as a “browser” for sending and receiving HTTP messages to and from an HTTP server at system 716. Such an HTTP server might be implemented as the sole network interface between system 716 and network 714, but other techniques might be used as well or instead. In some implementations, the interface between system 716 and network 714 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 716, shown in FIG. 7, implements a web-based customer relationship management (CRM) system. For example, in one embodiment, system 716 includes application servers configured to implement and execute CRM software applications as well as provide related data, code, forms, webpages and other information to and from user systems 712 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 716 implements applications other than, or in addition to, a CRM application. For example, system 716 may provide tenant access to multiple hosted (standard and custom) applications, including a CRM application. User (or third party developer) applications, which may or may not include CRM, may be supported by the application platform 718, which manages creation, storage of the applications into one or more database objects and executing of the applications in a virtual machine in the process space of the system 716.

One arrangement for elements of system 716 is shown in FIG. 7, including a network interface 720, application platform 718, tenant data storage 722 for tenant data 723, system data storage 724 for system data 725 accessible to system 716 and possibly multiple tenants, program code 726 for implementing various functions of system 716, and a process space 728 for executing MTS system processes and tenant-specific processes, such as running applications as part of an application hosting service. Additional processes that may execute on system 716 include database indexing processes.

Several elements in the system shown in FIG. 7 include conventional, well-known elements that are explained only briefly here. For example, each user system 712 could include a desktop personal computer, workstation, laptop, PDA, cell phone, or any wireless access protocol (WAP) enabled device or any other computing device capable of interfacing directly or indirectly to the Internet or other network connection. User system 712 typically runs an HTTP client, e.g., a browsing program, such as Edge from Microsoft, Safari from Apple, Chrome from Google, or a WAP-enabled browser in the case of a cell phone, PDA or other wireless device, or the like, allowing a user (e.g., subscriber of the multi-tenant database system) of user system 712 to access, process and view information, pages and applications available to it from system 716 over network 714. Each user system 712 also typically includes one or more user interface devices, such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 716 or other systems or servers. For example, the user interface device can be used to access data and applications hosted by system 716, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 712 and all of its components are operator configurable using applications, such as a browser, including computer code run using a central processing unit such as an Intel Core series processor or the like. Similarly, system 716 (and additional instances of an MTS, where more than one is present) and all of their components might be operator configurable using application(s) including computer code to run using a central processing unit such as processor system 717, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 716 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 716 is configured to provide webpages, forms, applications, data and media content to user (client) systems 712 to support the access by user systems 712 as tenants of system 716. As such, system 716 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 8 also illustrates environment 710. However, in FIG. 8 elements of system 716 and various interconnections in an embodiment are further illustrated. FIG. 8 shows that user system 712 may include processor system 712A, memory system 712B, input system 712C, and output system 712D. FIG. 8 shows network 714 and system 716. FIG. 8 also shows that system 716 may include tenant data storage 722, tenant data 723, system data storage 724, system data 725, User Interface (UI) 830, Application Program Interface (API) 832, PL/SOQL 834, save routines 836, application setup mechanism 838, applications servers 800₁-800_{N}, system process space 802, tenant process spaces 804, tenant management process space 810, tenant storage area 812, user storage 814, and application metadata 816. In other embodiments, environment 710 may not have the same elements as those listed above and/or may have other elements instead of, or in addition to, those listed above.

User system 712, network 714, system 716, tenant data storage 722, and system data storage 724 were discussed above in FIG. 7. Regarding user system 712, processor system 712A may be any combination of one or more processors. Memory system 712B may be any combination of one or more memory devices, short term, and/or long term memory. Input system 712C may be any combination of input devices, such as one or more keyboards, mice, trackballs, scanners, cameras, and/or interfaces to networks. Output system 712D may be any combination of output devices, such as one or more monitors, printers, and/or interfaces to networks. As shown by FIG. 8, system 716 may include a network interface 720 (of FIG. 7) implemented as a set of HTTP application servers 800, an application platform 718, tenant data storage 722, and system data storage 724. Also shown is system process space 802, including individual tenant process spaces 804 and a tenant management process space 810. Each application server 800 may be configured to tenant data storage 722 and the tenant data 723 therein, and system data storage 724 and the system data 725 therein to serve requests of user systems 712. The tenant data 723 might be divided into individual tenant storage areas 812, which can be either a physical arrangement and/or a logical arrangement of data. Within each tenant storage area 812, user storage 814 and application metadata 816 might be similarly allocated for each user. For example, a copy of a user's most recently used (MRU) items might be stored to user storage 814. Similarly, a copy of MRU items for an entire organization that is a tenant might be stored to tenant storage area 812. A UI 830 provides a user interface and an API 832 provides an application programmer interface to system 716 resident processes to users and/or developers at user systems 712. The tenant data and the system data may be stored in various databases, such as one or more Oracle™ databases.

Application platform 718 includes an application setup mechanism 838 that supports application developers' creation and management of applications, which may be saved as metadata into tenant data storage 722 by save routines 836 for execution by subscribers as one or more tenant process spaces 804 managed by tenant management process 810 for example. Invocations to such applications may be coded using PL/SOQL 834 that provides a programming language style interface extension to API 832. A detailed description of some PL/SOQL language embodiments is discussed in commonly owned U.S. Pat. No. 8,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 816 for the subscriber making the invocation and executing the metadata as an application in a virtual machine.

Each application server 800 may be communicably coupled to database systems, e.g., having access to system data 725 and tenant data 723, via a different network connection. For example, one application server 800₁ might be coupled via the network 714 (e.g., the Internet), another application server 800_{N-1} might be coupled via a direct network link, and another application server 800_{N} might be coupled by yet a different network connection. Transfer Control Protocol and Internet Protocol (TCP/IP) are typical protocols for communicating between application servers 800 and the database system. However, it will be apparent to one skilled in the art that other transport protocols may be used to optimize the system depending on the network interconnect used.

In certain embodiments, each application server 800 is configured to handle requests for any user associated with any organization that is a tenant. Because it is desirable to be able to add and remove application servers from the server pool at any time for any reason, there is preferably no server affinity for a user and/or organization to a specific application server 800. In one embodiment, therefore, an interface system implementing a load balancing function (e.g., an F5 BIG-IP load balancer) is communicably coupled between the application servers 800 and the user systems 712 to distribute requests to the application servers 800. In one embodiment, the load balancer uses a least connections algorithm to route user requests to the application servers 800. Other examples of load balancing algorithms, such as round robin and observed response time, also can be used. For example, in certain embodiments, three consecutive requests from the same user could hit three different application servers 800, and three requests from different users could hit the same application server 800. In this manner, system 716 is multi-tenant, wherein system 716 handles storage of, and access to, different objects, data and applications across disparate users and organizations.

As an example of storage, one tenant might be a company that employs a sales force where each salesperson uses system 716 to manage their sales process. Thus, a user might maintain contact data, leads data, customer follow-up data, performance data, goals and progress data, etc., all applicable to that user's personal sales process (e.g., in tenant data storage 722). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 716 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 716 might also maintain system level data usable by multiple tenants or other data. Such system level data might include industry reports, news, postings, and the like that are sharable among tenants.

In certain embodiments, user systems 712 (which may be client systems) communicate with application servers 800 to request and update system-level and tenant-level data from system 716 that may require sending one or more queries to tenant data storage 722 and/or system data storage 724. System 716 (e.g., an application server 800 in system 716) automatically generates one or more SQL statements (e.g., one or more SQL queries) that are designed to access the desired information. System data storage 724 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
encrypting a first sub-row block of data using a first group of encryption keys, where each encryption key in the first group of encryption keys corresponds to an entity authorized to access the first sub-row block of data;
storing the first encrypted sub-row block of data in the database table;
encrypting a second sub-row block of data using a second group of encryption keys, where each encryption key in the second group of encryption keys corresponds to an entity authorized to access the second sub-row block of data;
storing the second encrypted sub-row block of data in the database table;
sending an encrypted block of data to an electronic device in response to a request for the first sub-row block of data, wherein the encrypted block of data comprises multiple sub-row blocks of data including the first encrypted sub-row block of data, such that the requesting electronic device can decrypt the first encrypted sub-row block of data, but not all of the encrypted block of data, using one of the encryption keys from the first group of encryption keys.

2. The method of claim 1 wherein the sub-row encryption comprises encrypting the data on a field-by-field basis.

3. The method of claim 1 wherein the sub-row encryption comprises encrypting the data on a record-by-record basis.

4. The method of claim 1 wherein encrypting data to be stored in a database table on a sub-row basis comprises encrypting the data with multiple keys for later decryption by individual keys.

5. The method of claim 1 further comprising adding a new key to keys that can access selected data by re-encrypting the selected data using with the keys and the new key.

6. The method of claim 1 further comprising removing a selected key from keys that can access selected data by re-encrypting the selected data using with the reduced set of keys.

7. A non-transitory computer-readable medium having stored thereon instructions that, when executed by one or more processors, are configurable to cause the one or more processors to:
encrypt a first sub-row block of data using a first group of encryption keys, where each encryption key in the first group of encryption keys corresponds to an entity authorized to access the first sub-row block of data;
store the first encrypted sub-row block of data in the database table;
encrypt a second sub-row block of data using a second group of encryption keys, where each encryption key in the second group of encryption keys corresponds to an entity authorized to access the second sub-row block of data;
store the second encrypted sub-row block of data in the database table;
send an encrypted block of data to an electronic device in response to a request for the first sub-row block of data, wherein the encrypted block of data comprises multiple sub-row blocks of data including the first encrypted sub-row block of data, such that the requesting electronic device can decrypt the first encrypted sub-row block of data, but not all of the encrypted block of data, using one of the encryption keys from the first group of encryption keys.

8. The non-transitory computer-readable medium of claim 7 wherein the sub-row encryption comprises encrypting the data on a field-by-field basis.

9. The non-transitory computer-readable medium of claim 7 wherein the sub-row encryption comprises encrypting the data on a record-by-record basis.

10. The non-transitory computer-readable medium of claim 7 wherein encrypting data to be stored in a database table on a sub-row basis comprises encrypting the data with multiple keys for later decryption by individual keys.

11. The non-transitory computer-readable medium of claim 7 further comprising instructions that, when executed by the one or more processors, are configurable to cause the one or more processors to add a new key to keys that can access selected data by re-encrypting the selected data using with the keys and the new key.

12. The non-transitory computer-readable medium of claim 7 further comprising instructions that, when executed by the one or more processors, are configurable to cause the one or more processors to remove a selected key from keys that can access selected data by re-encrypting the selected data using with the reduced set of keys.

13. A system comprising:
at least one physical memory device to provide a database;
one or more processors coupled with the at least one memory device, the one or more processors configurable to encrypt a first sub-row block of data using a first group of encryption keys, where each encryption key in the first group of encryption keys corresponds to an entity authorized to access the first sub-row block of data, to store the first encrypted sub-row block of data in the database table, to encrypt a second sub-row block of data using a second group of encryption keys, where each encryption key in the second group of encryption keys corresponds to an entity authorized to access the second sub-row block of data, to store the second encrypted sub-row block of data in the database table, to send an encrypted block of data to an electronic device in response to a request for the first sub-row block of data, wherein the encrypted block of data comprises multiple sub-row blocks of data including the first encrypted sub-row block of data, such that the requesting electronic device can decrypt the first encrypted sub-row block of data, but not all of the encrypted block of data, using one of the encryption keys from the first group of encryption keys.

14. The system of claim 13 wherein the sub-row encryption comprises encrypting the data on a field-by-field basis.

15. The system of claim 13 wherein the sub-row encryption comprises encrypting the data on a record-by-record basis.

16. The system of claim 13 wherein encrypting data to be stored in a database table on a sub-row basis comprises encrypting the data with multiple keys for later decryption by individual keys.
means for encrypting a first sub-row block of data using a first group of encryption keys, where each encryption key in the first group of encryption keys corresponds to an entity authorized to access the first sub-row block of data;
means for storing the first encrypted sub-row block of data in the database table;
means for encrypting a second sub-row block of data using a second group of encryption keys, where each encryption key in the second group of encryption keys corresponds to an entity authorized to access the second sub-row block of data;
means for storing the second encrypted sub-row block of data in the database table;

17. The system of claim 13 wherein the one or more processors are further configurable to add a new key to keys that can access selected data by re-encrypting the selected data using with the keys and the new key.

18. The system of claim 13 the one or more processors are further configurable to remove a selected key from keys that can access selected data by re-encrypting the selected data using with the reduced set of keys.

19. An apparatus comprising:
means for sending an encrypted block of data to an electronic device in response to a request for the first sub-row block of data, wherein the encrypted block of data comprises multiple sub-row blocks of data including the first encrypted sub-row block of data, such that the requesting electronic device can decrypt the first encrypted sub-row block of data, but not all of the encrypted block of data, using one of the encryption keys from the first group of encryption keys.
